(19) United States
(12) Patent Application Publication
(10) Pub. No.: US 2024/0324629 A1
(43) Pub. Date: Oct. 3, 2024

(54) METHOD FOR PRODUCING BEVERAGES BASED ON EGG WHITE

(71) Applicant: EUROVO SRL, Franzione S. Maria in Fabriago Lugo (IT)

(72) Inventors: Gabriele CRISTOFORI, Ferrara (IT); Roberto PIRAZZINI, Lugo (IT); Alessandro GHERARDI, Castel Guelfo Di Bologna (IT); Martin HINTERSTEINER-WENZEL, Oberndorf Bei Salzburg (AT)

(73) Assignee: EUROVO SRL, Franzione S. Maria in Fabriago Lugo (IT)

(21) Appl. No.: 18/293,145

(22) PCT Filed: Jul. 27, 2022
(86) PCT No.: PCT/IB2022/056918

§ 371 Date: Jan. 29, 2024

(30) Foreign Application Priority Data
Jul. 29, 2021 (IT) 102021000020243

(51) Int. Cl. A23L 2/38; A23C 11/10; A23J 3/04; A23L 2/46; A23L 2/68; A23L 2/76; A23L 15/00

(52) U.S. Cl. CPC A23L 2/38; A23C 11/10; A23J 3/04; A23L 2/46; A23L 2/68; A23L 2/76; A23L 15/00

(57) ABSTRACT

A method for producing beverages based on egg white, which comprises performing a first thermal treatment for heating a solution of egg white at a temperature comprised between 58° C. and 75° C. The method then comprises performing a first homogenization of the previously-heated solution of egg white, at a pressure higher than 70 bar, in order to obtain a beverage that has microbiological and organoleptic characteristics similar to cow's milk.

The present invention relates to a method for producing beverages based on egg white.

As is known, cow's milk is a basic component of our daily diet, used on its own or as an ingredient for other beverages (smoothies, cappuccinos and the like) and food preparations.

However, a significant segment of the population cannot consume cow's milk owing to intolerance to one or more of its components.

Such intolerances are generally associated with a lack of the enzyme for digesting lactose (the portion of carbohydrates of milk) or of various bovine proteins, which can give rise to allergies.

The known solutions for compensating this problem consist in adding an enzyme to the milk in order to degrade the lactose, thus producing lactose-free milk, or substituting cow's milk with milk of another type such as oat milk, almond milk and the like.

These substitute products represent partial solutions for the most part, owing to their difference in taste, color, stability, sweetness, composition or functional properties.

Among the known protein-rich foods, egg white represents a valid alternative to milk, since it is composed almost exclusively of substantially fat-free proteins and it has a very low sugar content.

However, egg white is not commonly considered a substitute for milk, owing to several factors.

Firstly, the microbiological characteristics of egg white and some indigestibility factors have contributed to the general conviction that raw egg white cannot be consumed.

Furthermore, like cow's milk, liquid egg white, after the egg is broken, undergoes contamination by a series of microorganisms, such as various different types of bacteria and fungi.

The main limitation that up to now has prevented egg white from being used as a valid substitute for cow's milk is represented by its tendency to coagulate rapidly at relatively low temperatures, causing the release of an odor similar to that of sulfur.

In general, the thermal stability of egg white is much lower than that of milk, owing to the higher protein content and to the prevalence of proteins having a relatively low stability to heat.

Of the principal egg proteins, ovotransferrin has the lowest denaturation temperature, with a heat stability index Tm comprised between 55° C. and 60° C., which determines, therefore, the maximum applicable temperature to which to subject the egg white during heat treatment for pasteurization.

It is therefore widely accepted in the literature that egg white is not adapted to be subjected to heat treatments above this temperature range, owing to the coagulation of the proteins and the impact on its function and taste.

The heat stability of egg white further depends on the pH value.

In fact, the best stability conditions of egg white are obtained at pH values of 4.5.

The low tolerance of heat of egg white therefore permits only limited pasteurization, which can stabilize the product and enable it to be kept for approximately 50 days at 4° C. and, after initial opening by the consumer, a few days.

WO1998001038A1 discloses a method that entails, under controlled temperature conditions, breaking the eggs and subsequently exposing the liquid egg white for an extended time to moderately high temperatures comprised between 40° C. and 48° C.

This method makes it possible to stabilize the product, enabling it to be preserved for several months at ambient temperature.

WO2016135547A1 on the other hand discloses a process that comprises substantially, after breaking the eggs, a complex sequence of cooling the liquid egg white followed by pasteurization, carried out in the subsequent 48 hours, at a temperature of 57° C. for a time comprised between 2 minutes and 3 minutes.

After this step of pasteurization comes a step of eliminating the air content, a step of correcting the pH with carbon dioxide, and an additional heat treatment at a low temperature comprised between 38° C. and 50°, for a time comprised between 6 hours and 48 hours, which makes it possible to obtain a longer shelf life with respect to WO1998001038A1, but less than 6 months of long-life cow's milk.

U.S. Pat. No. 5,019,407A discloses the pasteurization of an egg, based on mixing liquid egg white with liquid yolks at different temperatures, in order to obtain a pasteurized whole egg product.

Also known, as an alternative to heat treatment, is the method generally known as HHP (High Hydrostatic Pressure) processing.

However, this method, while capable of improving the microbiological characteristics of the food preparation obtained, is technologically more complex to implement and therefore expensive.

Furthermore, aggregation occurs of egg white subjected to this method, which has a negative impact on the properties of the final product obtained.

It is therefore evident that the methods described above do not make it possible to provide a final product that reproduces the organoleptic characteristics of milk, while retaining a sufficient heat stability to also allow its use as an ingredient in hot beverages, for example in cappuccino.

The aim of the present invention is to solve the above-mentioned drawbacks, by providing a method for producing beverages based on egg white that makes it possible to provide a beverage with organoleptic characteristics similar to those of cow's milk.

Within this aim, an object of the invention is to provide a method for producing beverages based on egg white that makes it possible to provide a beverage with a long shelf life at ambient temperature.

Another object of the present invention is to provide a method for producing beverages based on egg white that makes it possible to provide a beverage with a high heat stability.

Another object of the invention is to provide a method for producing beverages based on egg white that makes it possible to provide a beverage that has chemical/physical and organoleptic properties that make it suitable for use in various different food preparations as a substitute for cow's milk.

Another object of the present invention is to provide a method for producing beverages based on egg white that is of low cost, easily and practically implemented, and safe in use.

This aim and these and other objects which will become better evident hereinafter are achieved by a method for producing beverages based on egg white, which consists in:
performing a first thermal treatment for heating a solution of egg white at a temperature comprised between 58° C. and 75° C.;
performing a first homogenization of said heated egg white solution, at a pressure higher than 70 bar, in order to obtain a beverage that has microbiological and organoleptic characteristics similar to cow's milk.

Such aim and such objects are also achieved by a beverage, characterized in that it comprises egg white in proportions which can vary from approximately 0.1% to approximately 99.9%, and at least one component chosen preferably from water, additives and the like, said additives being of the type chosen preferably from an antioxidant, an acidity regulator and the like, said long-life beverage having a shelf life of more than 3 months at ambient temperature and having microbiological and organoleptic characteristics similar to cow's milk.

Usefully, such aim and such objects are also achieved by a food preparation, characterized in that it comprises a beverage that comprises egg white in proportions which can vary from approximately 0.1% to approximately 99.9%, and at least one component chosen preferably from water, additives and the like, said additives being of the type chosen preferably from an antioxidant, an acidity regulator and the like, said long-life beverage having a shelf life of more than 3 months at ambient temperature and having microbiological and organoleptic characteristics similar to cow's milk.

Further characteristics and advantages of the invention will become better apparent from the detailed description that follows of a preferred, but not exclusive, embodiment of the method for producing beverages based on egg white, according to the invention, which is illustrated by way of non-limiting example in the accompanying drawings wherein:

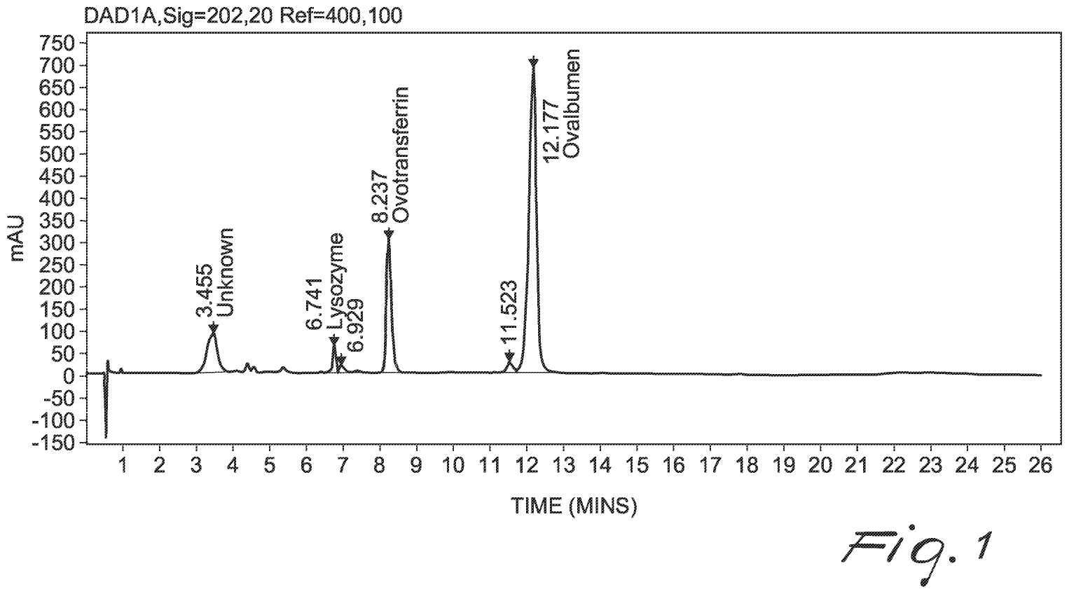

FIG. 1 is a graph of the concentration of the various components of liquid egg white from a hen's egg;

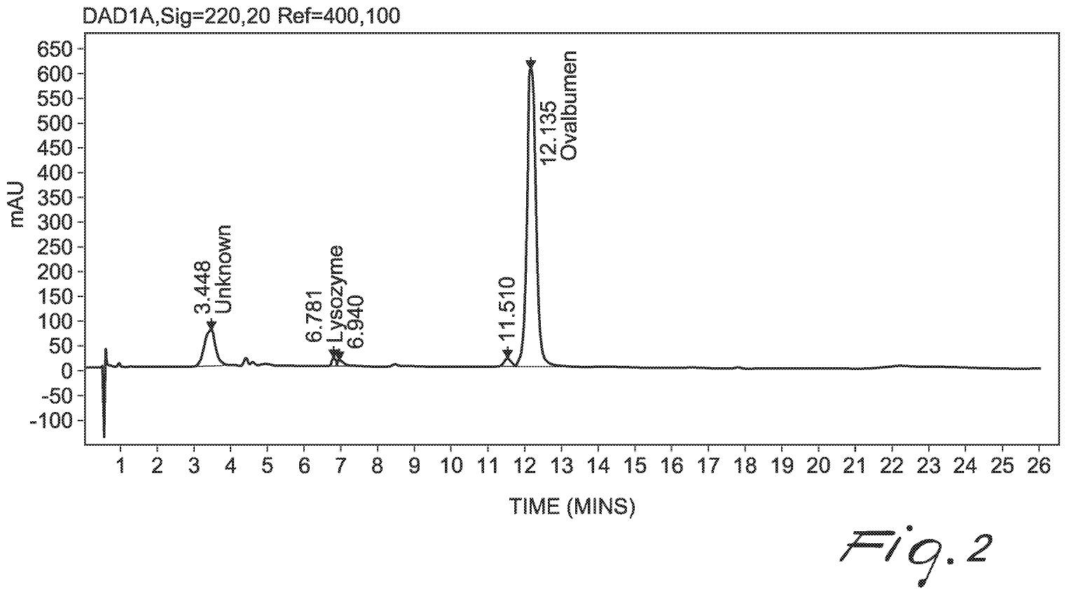

FIG. 2 is a graph of the concentration of the various components of liquid egg white from a hen's egg, after a first step of the method according to the invention;

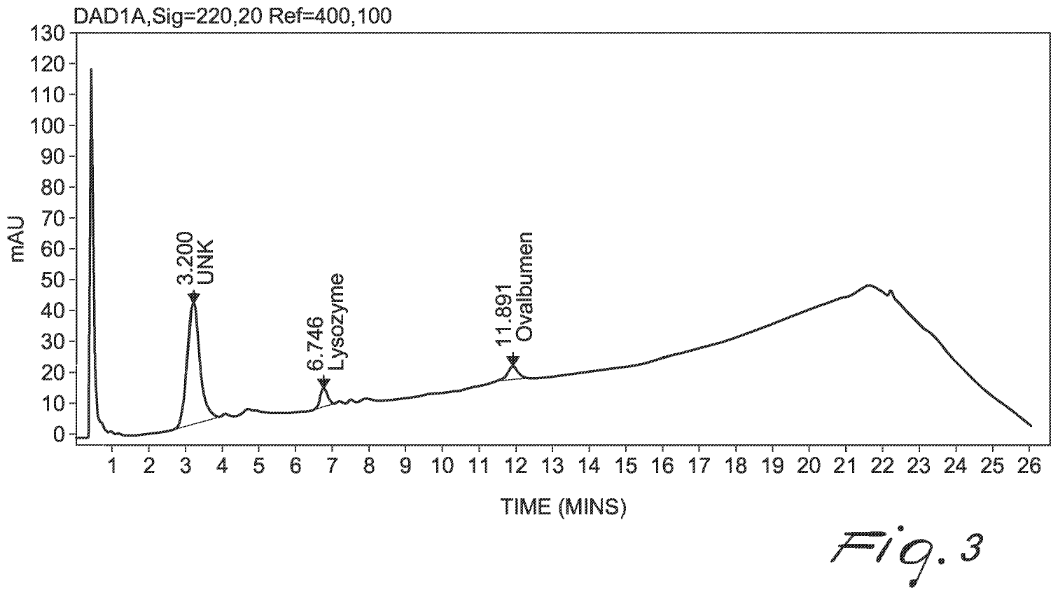

FIG. 3 is a graph of the concentration of the various components of liquid egg white from a hen's egg, after an intermediate step of the method according to the invention;

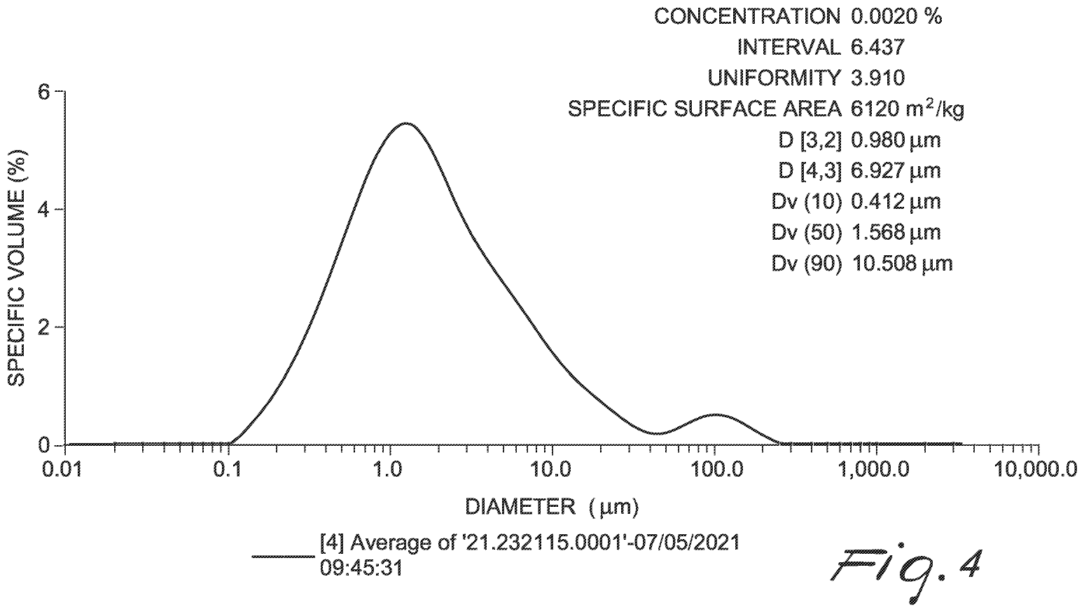

FIG. 4 is a graph of the particle size distribution of the solution of egg white, after an intermediate step of the method according to the invention.

The specific subject matter of the present discussion and of the protection claimed herein is a method for producing beverages based on egg white.

More precisely, it should be noted that, from this point onward, any reference made in the following pages to egg white should be understood as referring mainly, but not exclusively, to the egg white of a hen's egg.

According to the invention, the method consists in performing a first thermal treatment for heating a solution of egg white at a temperature comprised between 58° C. and 75° C.

The method then consists in performing a first homogenization of the previously-heated solution of egg white, at a pressure higher than 70 bar.

According to a preferred solution, this homogenization step is performed at a pressure comprised between 110 bar and 160 bar.

It should be noted that, by modifying the homogenization pressure, it is possible to modify the particle size of the beverage that is obtained with this method, as a function of the sensation on the palate that it is desired to obtain.

For example, a greater particle size will make it possible to replicate the sensation on the palate generated by whole cow's milk, while a smaller particle size will make it possible to replicate the sensation on the palate generated by low-fat milk.

The beverage based on egg white that is obtained after these two first steps presents a protein suspension, white in color and stable (only after several days, weeks or, in some cases, months will it separate from the solution), and a minimum deposit of solids.

It is therefore evident that, already after the first thermal treatment and a first homogenization step, the egg white beverage obtained already has many of the organoleptic characteristics of cow's milk in terms of color, sensation on the palate and foaming properties.

According to a preferred solution, the method can entail, after the first homogenization, a second thermal treatment for heating the beverage at a temperature comprised between 110° C. and 160° C.

In a further step, a second homogenization is performed on the beverage at a pressure comprised between 100 bar and 400 bar, in order to obtain a long-life beverage that has microbiological and organoleptic characteristics similar to cow's milk.

More advantageously, this second homogenization can be performed at a pressure comprised between 150 bar and 400 bar, followed by a step of partial evaporation.

The partial evaporation can be carried out by passing the solution through a throttle valve in order to instantaneously lower the temperature and enable it to then be packaged under aseptic conditions.

In an embodiment of significant practical interest, at least one component chosen from the solution of egg white and the beverage can comprise water with a weight ratio preferably comprised between 1 part egg white and 1 part water, and 1 part egg white and 4 parts water.

This weight ratio can preferably be comprised in the range of 1 part egg white and 2.5 parts water and 1 part egg white and 3.5 parts water.

It should be noted that the egg white, respectively of the solution and of the beverage, can be diluted with water, before the first or the second thermal treatment, in order to standardize the protein content of the egg white at a predefined value, with a favorable influence on the distribution of the particles.

It should be noted that, before a step preferably chosen from the first and the second thermal treatment of the egg white, it is possible to add, respectively to the solution of egg white and to the beverage, at least one additive of the type chosen preferably from an antioxidant, an acidity regulator and the like, in order to minimize, during the heating and homogenization steps, the release of unpleasant odors.

This additive can be ascorbic acid present with a dosage comprised between 1 g/kg and 100 g/kg of dry egg white protein in the liquid.

More preferably, the ascorbic acid present in the solution of egg white can be present with a dosage comprised between 20 g/kg to 60 g/kg of dry egg white proteins in the liquid.

It should be noted that the method, according to the invention, can entail, prior to a step chosen preferably from the first and the second thermal treatment of the egg white, performing a step of eliminating the air content, respectively from the solution and from the beverage, in order to limit the content of oxygen and therefore reduce the onset of oxidation phenomena.

This step of eliminating the air content can be performed using devices of known type.

The possibility is not ruled out, prior to a step chosen preferably from the first and the second thermal treatment of the egg white, of administering carbon dioxide, respectively to the solution and to the beverage, for a time comprised between 30 minutes and 2 hours, in order to limit the content of oxygen and therefore reduce the onset of oxidation phenomena.

The possibility is also not ruled out of administering carbon dioxide for the length of time necessary to arrive at a neutral pH.

Such administration can preferably be performed using a pump.

Conveniently, in an embodiment of significant practical interest, but which in any case does not limit the invention, in the first thermal treatment the solution of egg white can be heated at a temperature comprised between 60° C. and 73° C. and more advantageously between 62° C. and 70° C.

In any case other embodiments of the method are not ruled out, which entail heating such solution of egg white at a temperature comprised between 120° C. and 140° C. and more advantageously between 125° C. and 135° C.

In addition to the method, the specific subject matter of the present discussion and of the protection claimed herein also relates to a beverage that comprises egg white in proportions that can vary from approximately 0.1% to approximately 99.9%, and at least one component preferably chosen from water, additives and the like.

Such additives can be of the type preferably chosen from an antioxidant, an acidity regulator and the like.

Such beverage has a shelf life longer than 3 months at ambient temperature and has microbiological and organoleptic characteristics similar to cow's milk.

The specific subject matter of the present discussion and of the protection claimed herein also relates to a food preparation that comprises a beverage that comprises egg white in proportions that can vary from approximately 0.1% to approximately 99.9%, and at least one component preferably chosen from water, additives and the like.

Such additives can be of the type preferably chosen from an antioxidant, an acidity regulator and the like.

Such beverage has a shelf life longer than 3 months at ambient temperature and has microbiological and organoleptic characteristics similar to cow's milk.

As proof of the efficacy of the method according to the invention, the accompanying FIGS. 1, 2 and 3 show the RP-HPLC chromatogram respectively of a sample of standard egg white, of the solution of egg white after the first thermal treatment, and of the beverage based on egg white after the second thermal treatment.

It should be noted that the RP-HPLC chromatogram is a chart that shows the concentration of the different components of a mixture, obtained through Reversed-Phase High Performance Liquid Chromatography (RP-HPLC).

In particular, FIG. 1, which shows the RP-HPLC chromatogram of a sample of standard egg white, diluted with a weight ratio of 1 part egg white and 100 parts water, shows the presence of the three principal proteins of egg white: i.e. lysozyme (approximately 3.5% of the dry substance), ovotransferrin (approximately 12.5% of the dry substance), and ovalbumen (approximately 50% of the dry substance).

From an analysis of the chromatograms of FIGS. 1, 2 and 3, it is evident that, after each heat treatment, there is a decrease of these proteins in the soluble fraction, until they are almost eliminated.

As further support of the efficacy of the method according to the invention, the accompanying FIG. 4 shows a graph of the particle size distribution of the long-life beverage, according to the invention.

In particular, it can be seen that the part of the heat-sensitive proteins has a nano-suspension with a variable particle size comprised between 100 nm and 30 μm, with an average particle size of approximately 1 μm.

It should be noted that the size of the particles was detected with conventional instruments based on light diffusion.

In order to clarify which are the different embodiments of the method, according to the invention, and the different food preparations that can be obtained with such method, below some examples are given.

It should be noted that such examples are given solely for the purposes of illustration and cannot therefore be considered applicable to a limitation of the scope of protection of the present invention.

### EXAMPLE 1

The egg white in the liquid state (500 ml) undergoes a first thermal treatment which consists of slowly heating in a bain-marie, while stirring, the egg white until it reaches a temperature of approximately 52° C.

Once this temperature has been reached, the egg white is then heated more rapidly, again while constantly stirring, until it reaches 58° C., and once this is reached the egg white is kept at that temperature for approximately 8 minutes.

Once this first thermal treatment is finished, the method proceeds by cooling the egg white, by immersion in an ice bath, while stirring, and subsequently it is homogenized at a pressure of approximately 100 bar.

In this way a milky suspension of neutral taste is obtained, which shows a minimum deposit over time.

It should be noted that the product thus obtained, subjected to HPLC analysis, shows the absence of ovotransferrin.

It should be noted that in order to perform such analysis, a sample is taken of the product obtained and is subjected for 5 minutes to a centrifuge at 20,000 RPM, after which the sample is diluted with water, with a weight ratio of 1 part egg white and 100 parts water.

Then 5 microliters of this mixture is analyzed on standard HPLC, using an acetonitrile/water gradient of from 5% to 90% and a protein C4 column.

### EXAMPLE 2

In a first step, ascorbic acid (approximately 120 grams) is added to the egg white (30 liters), in order to obtain a pH value of the solution equal to 7.0. This solution of egg white is then heated to 52° C. for 60 minutes.

Then the solution of egg white is diluted with water, with a weight ratio of 1 part egg white and 2 parts water (60 liters).

The resultant mixture undergoes a first thermal treatment, using a heat exchanger, which consists of heating it and keeping it at 75° C. for 4 minutes.

Subsequently, the mixture is homogenized with a homogenization unit at a pressure of 140 bar.

The milky suspension thus obtained is then subjected to a second thermal treatment at high temperature, using a tubular heat exchanger.

This second treatment consists of preheating the milky solution, at a temperature comprised between 70° C. and 75° C., and heating, at a temperature of 120° C. for 10 seconds.

Subsequently, the suspension is then homogenized, using two respective homogenization units, at a pressure of 180 bar.

The method concludes by carrying out a rapid cooling, using a plate-type heat exchanger.

### EXAMPLE 3

This is conducted as in example 2, except for adding tartaric acid to adjust the pH of the egg white.

### EXAMPLE 4

This is conducted as in example 2, except for adding citric acid to adjust the pH of the egg white.

### EXAMPLE 5

In a first step, ascorbic acid (approximately 7.5 kilograms) is added to the egg white (2,000 liters), in order to obtain a pH value of the solution equal to 7.0.

This solution of egg white is then slowly preheated at a temperature comprised between 48° C. and 52° C. in a tank.

This tank is connected to a heat exchanger, to a pasteurization line and to a homogenization unit, which is adapted to supply a homogenization pressure of 140 bar.

After the preheating, the solution of egg white is diluted with the addition of 4,000 liters of water and introduced into the pasteurization unit, where it is heated at a temperature comprised between 71° C. and 72° C. for 3 minutes.

The solution of egg white is then transferred to the homogenization unit, and subsequently cooled using a heat exchanger. The solution of egg white, thus obtained, is then subjected to a second thermal treatment at high temperature, of the direct type performed using a tubular heat exchanger.

This second treatment entails preheating at a temperature comprised between 71° C. and 72° C., and a step of heating, performed via the direct injection of hot steam, which brings the temperature of the solution almost instantly to 140° C., for a length of time of approximately 4 seconds.

Subsequently, the solution of egg white is cooled to 75° C., homogenized, in two steps, at a pressure of 300 bar, and rapidly cooled using a plate-type heat exchanger.

At this point the product is sterile and, after further cooling to a temperature comprised between 15° C. and 20° C., is packaged aseptically.

The milky solution thus obtained is stable at ambient temperature for several months and has organoleptic characteristics similar to cow's milk.

### EXAMPLE 6

In a first step, tartaric acid is added to the egg white (2,000 liters), in order to obtain a pH value of the solution equal to 7.0.

Then, ascorbic acid (200 g) is also added to this solution of egg white.

Then the method proceeds as in example 5. The milky solution thus obtained is stable at ambient temperature for several months and has organoleptic characteristics similar to milk.

### EXAMPLE 7

This is conducted as in example 5, except for adding ascorbic acid (approximately 20 kilograms) at the start, and without further addition of antioxidant.

A final product is thus obtained with organoleptic properties similar to cow's milk, without unpleasant odors similar to the odor of sulfur.

### EXAMPLE 8

The final product obtained in example 5 is placed in a stainless steel container and introduced into a conventional foam generator, present in coffee machines available on the market.

The foam thus obtained is added to a coffee, thus obtaining a beverage with organoleptic characteristics similar to cappuccino.

### EXAMPLE 9

250 g of rice is heated with a spoonful of butter in a pot.

Added to this mixture of rice and butter, heated while stirring, is 4 spoonfuls of sugar and 1 liter of product, obtained with the method described in example 5, and the mixture is brought to the boil while constantly stirring.

The solution is left to boil for another 30 minutes while stirring repeatedly and after approximately 30 minutes, a food product is obtained with organoleptic characteristics similar to rice pudding.

### EXAMPLE 10

150 grams of sugar and 20 grams of gelatin is added to 850 grams of product, obtained with the method described in example 5.

The mixture thus obtained is heated, while stirring, to a temperature of 80° C. and is poured into containers with a capacity of approximately 80 grams. The containers are then placed in a freezer or blast chiller.

After 2 hours of being kept in a refrigerated condition, a dessert is obtained with organoleptic characteristics similar to panna cotta pudding.

### EXAMPLE 11

15 grams of sugar, 25 grams of butter, 6 grams of yeast, 125 grams of flour and 100 grams of liquid from whole eggs are added to 200 grams of product, obtained using the method described in example 6.

The compound thus obtained is amalgamated and poured into a pot for cooking. In this way a food product is obtained with a structure, texture and flavor similar to pancakes.

### EXAMPLE 12

Ascorbic acid (2 kilograms) is added to fresh liquid egg white (2,000 liters).

Then the pH of the solution of egg white is adjusted to a value of 7.0, using citric acid.

The solution is slowly preheated to 52° C., using a plate-type heat exchanger, and subsequently diluted by adding 4,000 liters of water.

To this solution, sucrose (48 kilograms), sodium chloride (6 kilograms), and white chocolate flavoring (1.5 kilograms) are added. This mixture is introduced into a pasteurization unit (like the unit described above in example 2) to cause a heating at a temperature of 68° C. for 3 minutes, and transferred to a homogenization unit and subjected to a pressure of 140 bar.

The suspension, thus obtained, is then subjected to a second thermal treatment at high temperature, of the direct type, using a tubular heat exchanger.

This second treatment entails preheating at a temperature comprised between 74° C. and 75° C., and a step of heating, performed via the direct injection of hot steam, which brings the temperature of the solution almost instantly to 130° C., for a length of time of approximately 6 seconds.

Subsequently, the solution of egg white is cooled at 75° C., homogenized, in two steps, respectively at a pressure of 200 bar and 250 bar, and rapidly cooled using a plate-type heat exchanger.

At this point the product is sterile and, after further cooling at a temperature comprised between 15° C. and 20° C., is packaged aseptically.

### EXAMPLE 13

The method is as described in example 12, with the difference that, prior to executing the second thermal treatment at high temperature, the solution is subjected to a step of eliminating the air content using a conventional deaerator, available on the market, for approximately 60 minutes.

### EXAMPLE 14

The method is as described in example 12, with the difference that the pH adjustment is effected by administering carbon dioxide until the pH value of 7.0 is reached.

### EXAMPLE 15

Ascorbic acid (3 kilograms) is added to fresh liquid egg white (2,000 liters).

The solution is then diluted with the addition of 4,000 liters of water and preheated slowly at a temperature of 52° C., using a plate-type heat exchanger.

After the preheating, sucrose (48 kilograms), sodium chloride (6 kilograms), and white chocolate flavoring (1.5 kilograms) are added.

The mixture thus obtained is introduced into a pasteurization unit (of the type described in example 2) where it is heated to the temperature of 62° C. for 3 minutes and subsequently transferred to a homogenization unit and subjected to a pressure of 130 bar.

Then the mixture is cooled, with a plate-type heat exchanger, at a temperature of 4° C.

At this point the pH is adjusted by administering carbon dioxide until the pH value of 6.5 is reached.

The mixture is then subjected to a second thermal treatment at high temperature, of the direct type, using a tubular heat exchanger.

This second treatment entails preheating at a temperature comprised between 70° C. and 75° C., and a step of heating, performed via the direct injection of hot steam, which brings the temperature of the solution almost instantly to 145° C., for a length of time of approximately 6 seconds.

Subsequently, the solution of egg white is cooled at 75° C., homogenized, in two steps, respectively at a pressure of 200 bar and 250 bar, and rapidly cooled using a plate-type heat exchanger.

At this point the product is sterile and, after further cooling at a temperature comprised between 15° C. and 20° C., is packaged aseptically.

It is therefore evident that the application of a defined and limited thermal stress to egg white, combined with a homogenization at a moderate pressure, generally conducted in at least two consecutive steps, makes it possible to obtain a nano-suspension of egg white that is biophysically and microbiologically stable.

Furthermore, such nano-suspension can be standardized, before or after the first thermal treatment, with water in order to obtain the desired protein content.

The product thus obtained assumes a milk-white appearance and a texture that is reminiscent of cow's milk.

The method can also entail the addition of further ingredients to the solution of egg white, in order to modify the organoleptic properties of the product and make it more similar to cow's milk.

The product thus obtained displays a heat stability during the step of cooking which is similar to cow's milk, with the same foaming properties.

Furthermore, with the method according to the invention a sterile product is obtained which is similar to long-life milk without additional denaturation, coagulation, decomposition or excessive buildup of egg proteins, leading to oxidation phenomena that result in unpleasant odors and tastes.

Furthermore, the addition of additives makes it possible to reduce any development of such unpleasant odors similar to sulfur.

Advantageously, the method for producing beverages based on egg white makes it possible to provide a beverage with organoleptic characteristics similar to those of cow's milk.

Usefully, the method according to the invention makes it possible to provide a beverage with a long shelf life.

Conveniently, the method for producing beverages based on egg white makes it possible to provide a beverage with a high heat stability.

Conveniently, the method according to the invention makes it possible to provide a beverage that has chemical/physical and organoleptic properties that make it suitable for use in various different food preparations as a substitute for cow's milk.

The invention, thus conceived, is susceptible of numerous modifications and variations, all of which are within the scope of the appended claims. Moreover, all the details may be substituted by other, technically equivalent elements.

In the embodiments illustrated, individual characteristics shown in relation to specific examples may in reality be interchanged with other, different characteristics, existing in other embodiments.

In practice, the materials employed, as well as the dimensions, may be any according to requirements and to the state of the art.

The disclosures in Italian Patent Application No. 102021000020243 from which this application claims priority are incorporated herein by reference.

1.-11. (canceled)

12. A method for producing beverages based on egg white, which consists in:
performing a first thermal treatment for heating a solution of egg white at a temperature comprised between 58° C. and 75° C.;
performing a first homogenization of said heated egg white solution, at a pressure higher than 70 bar, in order to obtain a beverage that has microbiological and organoleptic characteristics similar to cow's milk.

13. The method according to claim 12, comprising, after said first homogenization, in performing:
a second thermal treatment for heating said beverage at a temperature comprised between 110° C. and 160° C.;
performing on said beverage a second homogenization at a pressure comprised between 100 bar and 400 bar, in order to obtain a long-life beverage that has microbiological and organoleptic characteristics similar to cow's milk.

14. The method according to claim 12, wherein at least one component chosen from said solution of egg white and said beverage comprises water with a weight ratio preferably comprised between 1 part egg white and 1 part water, and 1 part egg white and 4 parts water.

15. The method according to claim 13, comprising, prior to the step chosen preferably from said first and said second thermal treatment of the egg white, adding, respectively to said solution of egg white and to said beverage, at least one additive of the type chosen preferably from an antioxidant, an acidity regulator and the like, in order to minimize, during said heating and homogenization steps, the release of unpleasant odors.

16. The method according to claim 15, wherein said at least one additive is ascorbic acid present with a dosage comprised between 1 g/kg and 100 g/kg of dry egg white protein in the liquid.

17. The method according to claim 13, comprising, prior to the step chosen preferably from said first and said second thermal treatment of the egg white, performing a step of eliminating air content, respectively from said solution and from said beverage, in order to limit a content of oxygen and therefore reduce onset of oxidation phenomena.

18. The method according to claim 13, comprising, prior to the step chosen preferably from said first and said second thermal treatment of the egg white, administering carbon dioxide, respectively to said solution and to said beverage, for a time comprised between 30 minutes and 2 hours, in order to limit a content of oxygen and therefore reduce onset of oxidation phenomena.

19. The method according to claim 12, wherein in said first thermal treatment said solution is heated to a temperature comprised between 60° C. and 73° C. and more favorably between 62° C. and 70° C.

20. The method according to claim 13, wherein in said second thermal treatment said beverage is heated to a temperature comprised between 120° C. and 140° C. and more favorably between 125° C. and 135° C.

21. A beverage, comprising egg white in proportions which can vary from approximately 0.1% to approximately 99.9%, and at least one component chosen preferably from water, additives and the like, said additives being of the type chosen preferably from an antioxidant, an acidity regulator and the like, said beverage having a shelf life of more than 3 months at ambient temperature and having microbiological and organoleptic characteristics similar to cow's milk.

22. A food preparation, comprising a beverage that comprises egg white in proportions which can vary from approximately 0.1% to approximately 99.9%, and at least one component chosen preferably from water, additives and the like, said additives being of the type chosen preferably from an antioxidant, an acidity regulator and the like, said beverage having a shelf life of more than 3 months at ambient temperature and having microbiological and organoleptic characteristics similar to cow's milk.
